(19) United States
(12) Patent Application Publication
(10) Pub. No.: US 2014/0197608 A1
(43) Pub. Date: Jul. 17, 2014

(54) TOOL HOLDER AND TOOL ARRANGEMENT

(71) Applicant: Bilz Werkzeugfabrik GmbH & Co. KG, OSTFILDERN (DE)

(72) Inventor: Werner SCHNEIDER, ALTBACH (DE)

(21) Appl. No.: 14/150,042

(22) Filed: Jan. 8, 2014

(30) Foreign Application Priority Data
Jan. 14, 2013 (DE) 20 2013 100 177.5

(51) Int. Cl. B23Q 11/10; B23B 31/02; B23Q 3/12

(52) U.S. Cl. CPC B23Q 11/1023; B23Q 3/12; B23B 31/02; B23Q 11/1069
USPC 279/20

(57) ABSTRACT

The present invention relates to a tool holder, in particular a steep-taper shank type tool holder, the tool holder comprising at least one mounting surface, in particular a mounting cone, for being received and driven by a drive spindle, and further comprising at least one integrated fluid path for an operating fluid, wherein at least one flow blocking member is associated with the at least one fluid path and is configured to block or release the at least one fluid path in a manner depending on flow direction. The at least one flow blocking member may be configured and arranged such that it permits flow for the operating fluid in the intended direction of supply and does not permit flow for the operating fluid in opposition to the intended direction of supply. The tool holder may be arranged as a chuck or a clamping chuck, for example.

### CROSS-REFERENCES TO RELATED APPLICATIONS

This application claims priority from German utility model application 20 2013 100 177.5, filed on Jan. 14, 2013. The entire content of this priority application is incorporated herein by reference.

### BACKGROUND OF THE INVENTION

The present invention relates to a tool holder, in particular a steep-taper shank, comprising at least one mounting surface, in particular a mounting cone, for being received and driven by a drive spindle, and comprising at least one integrated fluid path for an operating fluid. Further, the invention relates to a tool arrangement comprising a tool holder of this kind and a machining tool that is received on the tool holder.

Tool holders of a general type are well known in the art. Tool holders may for example also be referred to as clamping chucks or, more generally, chucks. Tool holders are conventionally configured to receive a machining tool, for example a tool for stock removal, for example a drilling tool, lathing tool or milling tool. The tool holders may further comprise a defined mounting contour, in particular at least one mounting surface, in order to be received on a drive spindle and fixed in position, for example. Thus, the machining tool may be secured to the drive spindle indirectly with the aid of the tool holder. Tool holders may simplify the procedure of changing a tool. This may have an advantageous effect for example in the case of machining equipment that has magazines comprising a plurality of machining tools. One can think of a large number of machining procedures in which a plurality of different machining tools has to be used when machining a workpiece. Tool holders may comprise a suitable defined connection contour such that in particular automated tool change procedures can be simplified.

Furthermore, tool holders may be configured such that further functionalities are provided besides simply clamping and/or receiving the machining tool. These may include for example the supply of an operating fluid. The term operating fluid may generally be understood to mean a fluid which is supplied to a received machining tool, at least for the purpose of lubrication or cooling. Conventionally, such operating fluids may be used both for cooling and for lubrication. The term fluid may include both liquids (such as emulsions) and gases, with or without dissolved fine liquid or solid particles (such as aerosols).

Machining tools are known that comprise spindle drives for driving a drive spindle that have various configurations. These may differ in particular in respect of the orientation and positioning of supply lines for the operating fluid.

In principle, it is conceivable to construct a tool holder such that an integrated fluid path or a plurality of integrated fluid paths are provided so that different configurations among those mentioned above may be covered. In other words, a tool holder may comprise one or a plurality of (supply) connections for the operating fluid. Conventionally, however, not all the fluid paths provided in the tool holder are needed. For example, machining equipment comprising a drive spindle may be configured such that only a single fluid path of the tool holder can be coupled. Thus, it may be necessary to close off the other fluid path or paths securely in order reliably to prevent the operating fluid from escaping in an undesirable manner. Undesirable escape of this kind may for example include the operating fluid escaping by way of an inlet of a fluid path that has not been coupled up.

It is known in the art to close off unused fluid paths, in particular the inlet openings thereof, manually. Here, stoppers, locking screws, sealants or similar means may for example be used.

If a tool holder of this kind, in which at least some of the fluid paths are closed off manually, is to be used in a production machine comprising a different configuration (as regards the supply lines for the operating fluid), complex manual interventions are unavoidable. For example, a worker has to open and where necessary clean fluid paths that have been closed off (and/or their inlet openings). Further, it may be necessary to close off fluid paths that were previously opened (and/or their inlet openings). Manual modification of this kind is in principle prone to error. In particular, with an inexperienced worker there is a risk that the tool holder will not be sufficiently adjusted to the configuration of the machining equipment with the drive spindle. On the one hand, there is a risk of inadequate cooling or lubrication of the machining equipment and the workpiece to be machined. On the other, there is a risk that the operating fluid will escape from the tool holder in an uncontrolled manner and the machining equipment and/or the workpiece will be soiled or even damaged.

### SUMMARY OF THE INVENTION

In view of this, it is an object of the present invention to disclose a tool holder providing a plurality of configurations for supplying an operating fluid.

It is another object of the present invention to disclose a tool holder that allows for a change between several operating fluid supply configurations in a manner which is as little prone to error as possible or is, preferably, error-free.

It is yet another object of the present invention to disclose a tool holder providing a plurality of operating fluid supply configurations that is configured such that manual intervention by a worker can be simplified as far as possible or even avoided entirely.

According to one aspect these and other objects of the invention are achieved by a tool holder, in particular steep-taper shank, comprising at least one mounting surface, in particular a mounting cone, for being received and driven by a drive spindle, and comprising at least one integrated fluid path for an operating fluid, wherein at least one blocking member is associated with the at least one fluid path and is configured to block or release the at least one fluid path in a manner depending on direction.

According to the invention, it is in fact possible to utilize the fact that, in the event of an error, the operating fluid would escape or flow out along a fluid path (where appropriate one that is not closed off) in opposition to an intended direction of supply. In this way, the at least one blocking member may be configured and arranged such that it permits flow for the operating fluid in the intended direction of supply and does not permit flow for the operating fluid in opposition to the intended direction of supply.

In other words, the at least one fluid path may be a selectively activated fluid path. Activation of the fluid path or paths may be performed in automated manner, in particular without human intervention, by the blocking member.

The term fluid path may be understood to mean a path for the operating fluid, which conventionally has an inlet and an outlet, wherein at least one flow channel is provided between the inlet and the outlet and is delimited by walls of a surrounding region. The fluid path typically has an intended direction of supply or an intended direction of through-flow.

Even if the tool holder has only one fluid path, equipping it with a blocking member of this kind may be advantageous, for example to prevent soiled fluid from flowing back through the inlet.

According to a further embodiment, the tool holder has at least two integrated fluid paths for the operating fluid, wherein the at least one blocking member is configured to block or release at least one of the fluid paths in a manner depending on direction.

In a preferred further development, the at least one blocking member is configured to block or release the at least one fluid path in a manner depending on pressure.

In other words, the at least one blocking member may be switched, for example on the basis of a pressure difference between two sides that are separated by the at least one blocking member.

In a preferred further development, the at least two fluid paths are configured for feeding the same operating fluid, wherein the operating fluid is at least a coolant or a lubricant. The operating fluid may in particular be an operating fluid which is usable both for cooling and for lubrication. In this context, it should be noted that the operating fluid need not in particular be a fluid for clamping. Tool holders are known that comprise hydraulic clamping means for clamping a machining tool. However, the construction and layout of such clamping means are subject to different requirements and boundary conditions than the layout of a system for supplying an operating fluid that can be used as a coolant or lubricant, which may in particular have different configurations as a result of a plurality of integrated fluid paths.

In an advantageous further development, at least one blocking member is associated with each fluid path. In this way, the tool holder can adopt a large number of fluid path configurations without the need for manual adjustments during modification.

In an advantageous further development, the at least one blocking member has a defined direction of throughput and a defined direction of blocking. Usually, the direction of throughput corresponds to the intended direction of through-flow of the operating fluid along the respective fluid path. The direction of blocking is usually the opposite direction thereto.

According to a further embodiment, the at least two fluid paths are connected to one another directly or indirectly. In other words, the at least two fluid paths may meet, for example in the tool holder. This may be done directly or indirectly. Meeting indirectly may be achieved for example by way of a path including further parts of the tool holder and/or the machining tool. A direct connection may occur for example if respective flow channels of the fluid paths cross one another or open out into one another. In principle, a direct or indirect connection between the at least two fluid paths would increase the risk of undesirable escape of the operating fluid. Since the at least one blocking member is arranged in at least one of the fluid paths, however, it is possible to prevent the operating fluid from passing in opposition to the intended direction of through-flow.

It is further preferred if the at least one blocking member may be controlled by the pressure of the operating fluid. In this way, the operating fluid may itself provide a regulating variable for the at least one blocking member, which functions as an actuator. It will be appreciated that the blocking member may be configured to be activated or deactivated by a pressure difference. The pressure difference may for example include a pressure difference between an atmospheric pressure and a pressure of the operating fluid. The operating fluid is usually supplied to the tool holder or the machining tool at a pressure significantly above atmospheric pressure. In this way, an unambiguously detectable regulating variable may be applied to the blocking member and utilized there.

In an advantageous further development, the at least one blocking member takes the form of a check valve. The term check valve may conventionally be understood to mean a component that permits the flow of a fluid only in one (throughput) direction. There are various types of check valves. Check valves may take the form of, for example, flap valves, ball valves, conical valves, tappet valves, mushroom valves and similar forms.

The at least one blocking member that takes the form of a check valve may comprise a blocking element and a mating contour that corresponds with the blocking element. The blocking element may be, for example, a flap, a ball, a cone, a disk, a tappet or similar. The blocking element and the mating contour may come into contact with one another to form a linear contact or a surface contact. Preferably, the mating contour is adjusted to the contour of the blocking element. A sealing surface may be provided between the blocking element and the mating contour. Usually, the blocking element is received movably in order to be displaced selectively between a blocking position and a throughput position. In the blocking position, the blocking element bears sealingly against the mating contour. In the throughput position, usually the blocking element is at least partly detached from the mating contour in order to permit through-flow through an opening in the mating contour.

In an advantageous further development, the at least one blocking member has a tensioning element that urges the blocking element towards a tensioning position. In this way, the functional reliability of the at least one blocking member, in particular the check valve, may be increased. In the tensioning position, the tensioning element bears sealingly against the mating contour. The tensioning element may be arranged, for example, as a tension spring. The tensioning element may take the form of a mechanical spring but furthermore may for example also take the form of a fluid spring. The tensioning element may urge the blocking element towards the tensioning position with a retaining force that defines a minimum pressure or minimum pressure difference. Only when an incoming operating fluid flowing in the direction of throughput has a pressure that overcomes the retaining force or minimum pressure can the blocking element be displaced towards a throughput position. In the throughput position, the blocking element is displaced in relation to the mating contour to permit throughput.

In an advantageous embodiment, each fluid path of the tool holder has at least one flow channel, which is made in the tool holder and has at least one inlet opening or outlet opening for the operating fluid. In particular, the tool holder may comprise a one-part base body in which the at least one flow channel of each fluid path is made, for example as a bore.

According to a further embodiment, a first fluid path has at least one central flow channel which runs in particular coaxially in relation to a longitudinal axis of the tool holder. In other words, this may be a central flow channel that passes through the tool holder, starting for example from a rearward side facing the drive spindle, towards a front side facing a machining tool or a receiver for a machining tool. It will be appreciated that the fluid path may comprise a plurality of flow channels arranged in rows or connected parallel to one another.

The rearward side of the tool holder may also be referred to as the spindle side. The front side of the tool holder may also be referred to as the tool side.

According to a further embodiment, a second fluid path has at least one lateral flow channel that runs at an angle, in particular an acute angle, to a longitudinal axis of the tool holder. Further, it is conceivable to provide the second fluid path with at least two lateral flow channels that each run at an acute angle to a longitudinal axis of the tool holder, wherein the respective acute angles open in opposing directions.

According to an exemplary embodiment, a first flow channel of the second fluid path may be at an acute angle that opens towards the spindle side, wherein a second flow channel of the second fluid path may be at an acute angle to the longitudinal axis that opens towards the tool side.

In an advantageous further development, the tool holder further has a collar, wherein at least one of the fluid paths has a flow channel that opens out at an axial face of the collar. The collar may be provided as an at least partly radially outwardly projecting contour on the tool holder. Preferably, the collar is configured to be at least partly rotationally symmetrical. The collar may for example be arranged as a so-called gripping collar, in order to enable the tool holder to be received in a defined manner using gripping tools. In this way, automated displacement of the tool holder may be simplified by providing a defined grip contour.

In particular the second fluid path, which has at least one lateral flow channel, may be configured such that the lateral flow channel opens out at the axial face of the collar. For this purpose, the flow channel may run at an angle to the longitudinal axis of the tool holder that is open towards the spindle side. In other words, the flow channel may open out at the spindle-side axial face of the collar.

Advantageously, the tool holder has at least one tool receiving surface for receiving a machining tool, in particular a receiving recess. The machining tool may be received fixedly and with an accuracy ensuring reproducibility on the tool receiving surface, in particular in the receiving recess. Further, the tool holder may be configured to secure the machining tool force-fittingly and/or form-fittingly. For this purpose, suitable clamping means may be provided on the tool holder.

According to a further development of this embodiment, the at least two integrated fluid paths open out at least indirectly or directly into the receiving recess in order to transfer the operating fluid to the machining tool. For example, at least one fluid path that opens out into the receiving recess of the tool holder (in the assembled condition) may also be provided in the machining tool.

The object of the invention is further achieved by a tool arrangement, comprising a tool holder according to one of the above-mentioned aspects and a machining tool, wherein the tool holder provides at least one selectively activated fluid path for an operating fluid, which may be supplied to the machining tool by way of a spindle.

It is understood that the features of the invention mentioned above and those yet to be explained below can be used not only in the respective combination indicated, but also in other combinations or in isolation, without leaving the scope of the invention.

### BRIEF DESCRIPTION OF THE DRAWINGS

Further features and advantages of the invention will be apparent from the description that follows of preferred exemplary embodiments, with reference to the drawings, in which:

FIG. 1 shows a simplified partial lateral cutaway illustration of a tool arrangement comprising a tool holder that can be received on a drive spindle and is configured to receive a machining tool; and

FIGS. 2a to 2d show simplified schematic views of blocking members that may for example be used in the tool holder shown in FIG. 1.

### DETAILED DESCRIPTION OF PREFERRED EMBODIMENTS

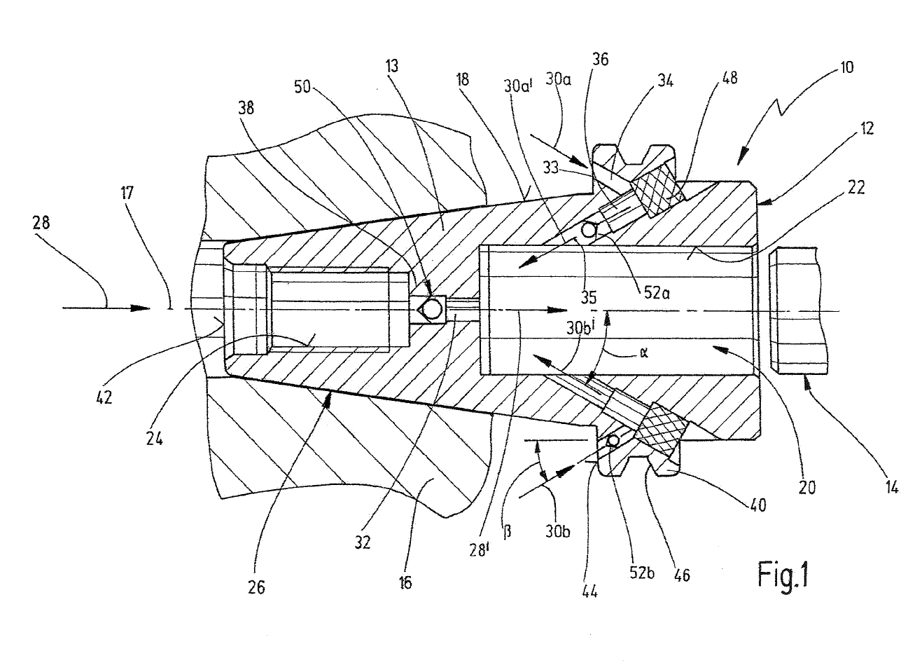

FIG. 1 shows a cutaway partial lateral illustration of a tool arrangement that is indicated generally by reference numeral 10.

The tool arrangement 10 has a tool holder 12, which may be constructed to receive a machining tool 14. FIG. 1 merely indicates, for reasons of clarity, a shank of the machining tool 14 in a cutaway partial illustration. The machining tool 14 may be for example a tool for stock removal. It will be appreciated that other types of machining tools 14 may also be used. Tools of the stock removal type may for example include drilling tools, milling tools, lathing tools or similar.

The tool holder 12 is further configured to be coupled to a drive spindle 16, which is shown in FIG. 1, again for reasons of clarity only in a simplified form in a cutaway partial illustration. The drive spindle 16 may be configured to drive the tool holder 12, together with the machining tool 14 which may be received therein, about a longitudinal axis 17, in particular to drive it in rotation. The tool holder 12 may comprise a base body 13 on which for example a mounting surface 18 is formed. According to an exemplary embodiment, the mounting surface 18 may be a conical mounting surface 18. The mounting surface 18 may be part of a mounting cone 26.

The mounting surface 18 may be formed, for example, with a steep taper. The tool holder 12 may comprise a steep-taper shank overall. Exemplary embodiments may comprise a steep-taper shank that is standardized for example to DIN 69871 or ISO 7388. It will be appreciated that the tool holder 12 may as an alternative also comprise a different taper, for example a hollow-shank taper. Further, the mounting surface 18 may also comprise a shape different from a conical shape or truncated conical shape. Further, a receiving recess 20 may be arranged in the base body 13 of the tool holder 12 and comprise for example at least a tool receiving surface 22.

The receiving recess 20 may provide a seat for the machining tool 14 to be received. The receiving recess 20 may in principle comprise a rotationally symmetrical shape. However, the receiving recess 20 may also comprise a cylindrical shape or a conical shape. Other shapes are conceivable. The receiving recess 20 may also comprise a shape that is not rotationally symmetrical. Instead of the receiving recess 20, which is created by a hollow in the base body 13, the tool holder 12 may as an alternative also comprise a receiver for a machining tool, this receiver being arranged for example as a projection on the base body 13.

In principle, embodiments in which the tool holder 12 and the machining tool 14 are arranged as an integrated component are also conceivable. In other words, the tool holder 12 may also be part of the machining tool 14 and vice versa. In the context of the description which follows, however, the assumption is made that the tool holder 12 and the machining tool 14 are arranged as separate components. Nonetheless, this should not be understood to be restrictive.

The receiving recess 20 is arranged at a tool-side end of the tool holder 12, which is also referred to as the tool side hereinafter. At its end remote from the tool-side end, the tool holder 12 has a spindle-sided end, which can also be referred to as the spindle side. At the spindle side of the tool holder 12, in an exemplary embodiment a securing hollow 24 may be made in the base body 13.

The tool holder 12 that is shown by way of example in FIG. 1 has a plurality of fluid paths. A first fluid path is illustrated by arrows that are designated by reference numbers 28 and 28′. The tool holder 12 has at least one further fluid path. By way of example, there is provided on the tool holder 12 at least one second fluid path, which is illustrated by arrows that are designated by reference numbers 30a and 30a′. A further fluid path is provided on the tool holder 12, and this is illustrated by arrows designated by reference numbers 30b, 30b′. In principle, both the path 30a, 30a′ and the path 30b, 30b′ may be considered a second fluid path 30. However, the paths 30a, 30a′ and 30b, 30b′ may also form the second fluid path 30 together, in combination. The first fluid path 28, 28′ runs substantially coaxially with the longitudinal axis 17. The fluid path 30a, 30a′ and the fluid path 30b, 30b′, which together function as a second fluid path 30, run obliquely or at an angle to the longitudinal axis 17, at least in certain sections.

The direction of the paths 28, 28′ on the one hand and 30a, 30a′ and 30b, 30b′ on the other respectively identify an intended direction of through-flow or an intended direction of throughput for an operating fluid that may be supplied to the tool holder 12 directly or indirectly by way of the drive spindle 16. The tool holder 12 is configured to feed the operating fluid, for example a coolant and/or lubricant, to the machining tool 14. The operating fluid may be fed through selectively by way of one of the fluid paths 28, 30. For reasons of clarity in the illustration, the paths 30a, 30a′ and 30b, 30b′ shown in FIG. 1 are to be considered together as fluid path 30 hereinafter.

The fluid path 28 passes through the base body 13 of the tool holder 12 axially and has at least one flow channel 32. The at least one flow channel 32 may take the form of an axial bore. The first fluid path 28 may comprise an inlet opening, which is provided at a spindle-side end of the tool holder 12 that is designated by reference number 42. The first fluid path 28 may open out into the receiving recess 20. The first fluid path 28 may pass through a central region 38 of the base body 13.

The second fluid path 30 may include one or more path portions 30a, 30b. The second fluid path 30 may include lateral flow channels that run obliquely at an angle to the longitudinal axis 17. For example, the path (portion) 30a, 30a′ has a flow channel 34 that runs at an angle β to the longitudinal axis 17, wherein the angle β opens towards the spindle side. Further, the path (portion) 30a, 30a′ may comprise a flow channel 36 that runs at an angle α obliquely to the longitudinal axis 17, wherein the angle α opens towards the tool side. In FIG. 1, the angles α, β are illustrated in the corresponding path (portion) 30b, 30b′, for reasons of clarity in the illustration.

Each of the fluid paths 28, 30 may comprise at least one inlet opening 33 and outlet opening 35. For example, in the case of the path (portion) 30a, 30a′, the inlet opening is designated by reference number 33, with the outlet opening being designated by reference number 35. The terms inlet and outlet correspond to the intended directions of flow of the fluid paths 28, 30.

The flow channel 34, which is in particular provided with the inlet opening 33, passes through a collar 40 that is arranged on the base body 13 of the tool holder 12. The inlet opening 33 opens out at an axial face 44 that faces the spindle side and may also be referred to as an axial abutment. The second fluid path 30 has curved or bent path (portions) 30a, 30a′ and 30b, 30b′. For reasons determined by manufacturing technology, the further flow path 36 may for example be arranged as a through bore, in which case an end of the flow channel 36 on the peripheral side may be closed off by a plug 48. The plug 48 may for example be a stopper, locking screw or similar. The outlet opening 35 of the flow channel 36 may open out into the receiving recess 20.

The collar 40 may further comprise a so-called gripper groove 46, which is made for example on the peripheral side thereof. The gripper groove 46 may provide a defined contour in order to simplify automated gripping and changing of the tool holder 12.

The drive spindle 16 may comprise a defined configuration in order to provide the tool holder 12 with the operating fluid. This may for example be a so-called central coolant supply. A central coolant supply may include supply of the coolant by way of a through bore of a pull stud which may be inserted into the securing hollow 24. A configuration of this kind may be referred to as an AD configuration. A further, alternative configuration may include a lateral coolant supply. This may in particular be performed by way of the collar 40. This may be a so-called B configuration. The tool holder 12 may be supplied with the coolant (or lubricant) according to both the AD configuration and the B configuration. It will be appreciated that further embodiments may also have different coolant supply configurations. The said configurations should therefore be considered merely as exemplary constructions.

However, in operation there is always a risk here that the operating fluid that is supplied will escape to the outside by way of the fluid path 28, 30 that is not currently being used. To avoid this disadvantageous effect, blocking members 50, 52 are provided in the tool holder 12 and are illustrated in simplified manner in FIG. 1, merely symbolically. The blocking members 50, 52 enable the operating fluid to pass through in a selective direction. The first fluid path 28 is provided with the blocking member 50. In the second fluid path 30, the blocking members 52a (in the path portion 30a, 30a′) and 52b (in the path portion 30b, 30b′) are provided. The positions of the blocking members 50, 52 that are shown in FIG. 1 should be understood merely as exemplary embodiments. An actual position of the blocking members 50, 52 in the respective fluid path 28, 30 may differ from this. Thus, for example in the case of the path portion 30a, 30a′ the blocking member 52a may be provided in the (inner) flow channel 36. By contrast, in the case of the path portion 30b, 30b′ the blocking member 52b may be provided in the outer flow channel, the one that corresponds to the flow channel 34 in the path portion 30a, 30a′.

The blocking members 50, 52 are configured to prevent through-flow of the operating fluid in opposition to the intended direction of flow or intended direction of through-flow that is predetermined by the respective fluid path 28, 30.

Preferably, blocking or release of the through-flow takes place in automated manner in the blocking member 50, 52, without operator intervention. To this end, the blocking members 50, 52 may take the form for example of a check valve or similar.

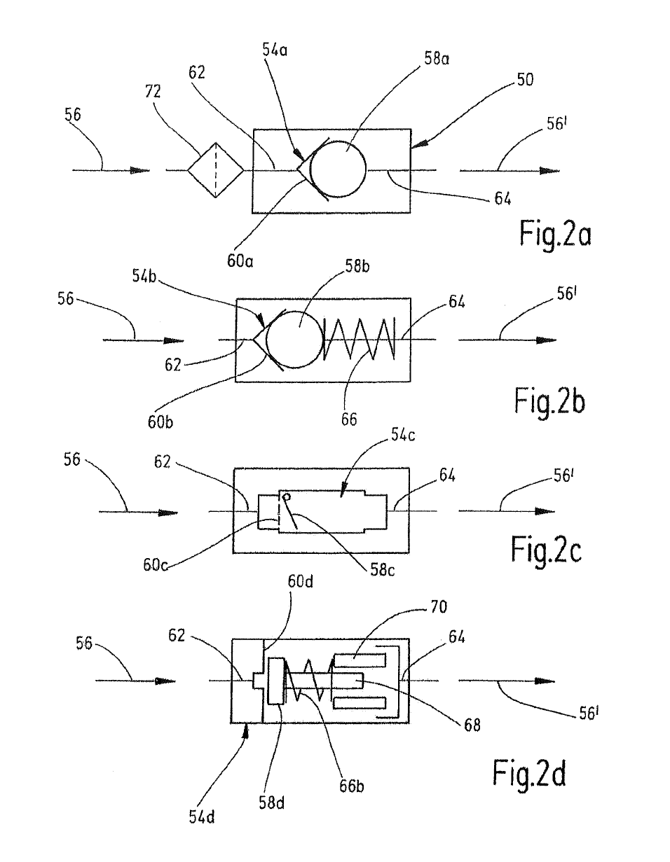

FIGS. 2a, 2b, 2c and 2d show various simplified symbolic illustrations of check valves 54a, 54b, 54c, 54d. The check valves 54 may in principle be used in any of the blocking members 50, 52. The check valves 54 comprise a defined direction of through-flow, illustrated by the arrows that are designated by reference numbers 56, 56′. The direction of through-flow 56, 56′ is intended to correspond with an intended direction of flow of the fluid paths 28, 28′ and 30a, 30a′, 30b, 30b′, which are illustrated in FIG. 1 by correspondingly designated arrows. Typically, the check valves 54 do not permit passage in opposition to the direction of throughput 56, 56′.

The check valve 54a that is shown in FIG. 2a has, by way of example, a blocking element 58a and a mating contour 60a. The blocking element 58a may for example be a blocking element 58a that is in the shape of a ball, at least in certain sections. In conjunction with this, the mating contour 60a may comprise a corresponding seat for the blocking element 58a. The check valve 54a may in particular be a ball-type check valve.

Each of the check valves 54 has an input side 62 and an output side 64. The input side 62 designates the side of the check valves 54 to which the operating fluid is fed as it flows in the direction of throughput 56, 56′. Opposite it, the output side 64 designates the side of the check valves 54 from which the operating fluid emerges from the check valves 54 as it flows in the direction of throughput 56, 56′. The check valves are configured to prevent opposite flow from the output side 64 towards the input side 62, wherein the direction in which an operating fluid attempts to flow through the check valves 54 is opposite to the direction of throughput 56, 56′. The positive pressure that arises on the output side 64 in the event of such a case displaces the blocking element 58 towards the mating contour 60 and thus closes off the check valve 54.

FIG. 2b shows a modified embodiment of a check valve that is designated by reference number 54b. As an addition to the embodiment of the check valve 54a that is shown in FIG. 2a, in the case of the check valve 54b a tensioning element 66 is further provided, which may also be referred to as a preloading element. The tensioning element 66 is configured to urge the blocking element 58b towards the mating contour 60 under a defined preload, even in an unpressurized condition. An unpressurized condition may prevail for example if there is no difference in pressure, or only an insignificant difference in pressure, between the input side 62 and the output side 64. Preloading that is generated by the tensioning element 66 can increase the operational reliability of the check valve 58b. The tensioning element 66 may be arranged, for example, as a tensioning spring. Mechanical springs, in particular metal springs, are for example conceivable, or indeed furthermore for example fluid springs.

FIG. 2c shows a further modification of a check valve that is designated by reference number 54c. The check valve 54c takes the form of a flap valve. The blocking element 58c may be formed by a flap that is received for example pivotally or rotatably. The blocking element 58c that takes the form of a flap may selectively block or release a corresponding mating contour 60c as a function of the pressure conditions between the input 62 and the output 64.

FIG. 2d shows a further, alternative embodiment of a check valve that is designated by reference number 54d. The check valve 54d takes the form of a mushroom check valve or a tappet check valve. An associated blocking element 58d may take the form of a disk and comprise a tappet 68 that is received such that it is displaceable on a guide 70 in the check valve 54d. Further, a tensioning element 66b may be provided that urges the blocking element 58d towards a corresponding mating contour 60d under preload, even in the unpressurized condition.

FIG. 2a further illustrates a filter element that is designated by reference number 72. The filter element 72 may be positioned upstream of the blocking member 50, as seen in the direction of throughput 56, 56′. The filter element 72 may for example be a filter cartridge or a similarly shaped filter element. The filter element 72 may in principle be positioned upstream of any of the blocking members 50, 52 illustrated by means of FIG. 1. The filter element 72 may protect the blocking members 50, 52 from excessive soiling and thus ensure the functional reliability of the blocking members 50, 52, which may in particular take the form of check valves or similar. Filter elements 72 for coolant or lubricant may generally be referred to as coolant/lubricant filters (KSS filters in German), for example.

Since the at least one blocking member 50, 52 typically includes moving components, it is advantageous to construct the filter element 72 such that particles large enough to clog the at least one blocking member 50, 52 are effectively filtered out of the flowing fluid, at least in normal operation in the intended direction of through-flow 56, 56′. It will be appreciated that the filter element 72 may in principle be used with any of the embodiments of blocking members 50, 52 that are illustrated by means of FIGS. 2a, 2b, 2c and 2d.

Accordingly, in various embodiments it may be particularly preferable if the tool holder is provided in accordance with the principles of the present disclosure with at least one filter element 72, which is arranged upstream of the at least one blocking member 50, 52, as seen in the direction of throughput 56, 56′.

Overall, within the scope of the invention a tool holder 12 is specified that, on the basis of various modifications, which may be implemented with little complexity, can provide a much broader functionality. In particular, the tool holder 12 may be arranged for a plurality of configurations of a spindle-side supply of coolant or lubricant and may be used without manual modification work. The tool holder 12 may be adjusted automatically, without further fitting work, to a given configuration of operating fluid supply.

What is claimed is:

1. A steep-tape shank type tool holder for mounting a machining tool, comprising:
a base body;
a mounting cone for mounting said tool holder to a drive spindle;
a receiving recess for receiving a machining tool;
a first fluid path integrated in said base body for conducting an operating fluid to said machining tool; and
at least a first flow blocking member arranged within said fluid path;
wherein said flow blocking member is configured for selectively blocking or releasing said fluid path, depending on an actual flow direction.

2. The tool holder as claimed in claim 1, further comprising at least a second fluid path integrated in said base body; and
at least a second flow blocking member arranged within said second fluid path;
wherein said first flow blocking member is configured for blocking said first fluid path when said second fluid path is supplied with said operating fluid; and
wherein said second flow blocking member is configured for blocking said second fluid path when said first fluid path is supplied with said operating fluid.

3. The tool holder as claimed in claim 2, wherein said first fluid path further comprises a central flow channel which is arranged coaxially with respect to a longitudinal axis of said tool holder.

4. The tool holder as claimed in claim 2, wherein said second fluid path further comprises at least one lateral flow channel which is arranged at an angle to said longitudinal axis of said tool holder.

5. The tool holder as claimed in claim 2, wherein said base body further comprises a collar; and
wherein at least one of said fluid paths further comprises a flow channel that leads to an axial face of said collar.

6. The tool holder as claimed in claim 1, wherein said flow blocking member is configured to block or release said fluid path, depending on pressure.

7. The tool holder as claimed in claim 1, wherein said flow blocking member is controllable by a pressure of said operating fluid.

8. The tool holder as claimed in claim 1, wherein said flow blocking member is arranged as a check valve; and
wherein said check valve comprises a flow blocking element and a mating contour.

9. The tool holder as claimed in claim 8, wherein said flow blocking member further comprises a tensioning element that is configured for urging said flow blocking element towards a tensioning position.

10. A tool holder, comprising:
at least one mounting surface for being received and driven by a drive spindle;
a first fluid path for an operating fluid; and
at least a first flow blocking member arranged within said fluid path;
wherein said flow blocking member is configured for blocking or releasing said fluid path, depending on flow direction.

11. The tool holder as claimed in claim 10, further comprising at least a second fluid path for said operating fluid; and
at least a second flow blocking member arranged within said second fluid path;
wherein each of said flow blocking members is configured to block or release a respective one of said fluid paths, depending on flow direction.

12. The tool holder as claimed in claim 11, wherein said fluid paths are configured for feeding the same operating fluid, wherein said fluid paths are directly or indirectly connected to one another, and wherein each fluid path of said fluid paths is associated with at least one flow blocking member.

13. The tool holder as claimed in claim 10, wherein said flow blocking member is configured to block or release said fluid path, depending on pressure; and
wherein said flow blocking member is controllable by a pressure of said operating fluid.

14. The tool holder as claimed in claim 10, wherein said flow blocking member is arranged as a check valve, wherein said check valve comprises a defined direction of throughput and a defined direction of flow blocking; and
wherein said check valve comprises a blocking element and a mating contour.

15. The tool holder as claimed in claim 14, wherein said flow blocking member comprises a tensioning element that urges said blocking element towards a tensioning position.

16. The tool holder as claimed in claim 10, wherein said fluid path comprises at least one flow channel which is integrated in said tool holder; and
wherein said flow channel comprises at least one of an inlet opening or an outlet opening for said operating fluid.

17. The tool holder as claimed in claim 10, further comprising at least one tool receiving surface for receiving a machining tool.

18. The tool holder as claimed in claim 17, wherein said fluid path leads, at least indirectly or directly, to said tool receiving surface.

19. The tool holder as claimed in claim 10, further comprising at least one filter element arranged within said fluid path;
wherein said filter element is positioned upstream, as seen in a direction of throughput, of said flow blocking member.

20. A tool arrangement, comprising:
a tool holder, comprising:
at least one mounting surface configured for being received and driven by
a drive spindle;
at least one fluid path for an operating fluid; and
at least one flow blocking member arranged within said fluid path;
wherein said flow blocking member is configured for blocking or releasing said fluid path, depending on flow direction; and
a machining tool attached to said tool holder;
wherein said at least one fluid path is configured for conducting said operating fluid from said drive spindle to said machining tool;
wherein said fluid path is selectively activatable by way of said flow blocking member; and
wherein said operating fluid is at least a coolant or a lubricant.
